(19) United States
(12) Patent Application Publication
(10) Pub. No.: US 2004/0040979 A1
(43) Pub. Date: Mar. 4, 2004

(54) Dispenser for food or beverage container

(75) Inventors: Jerold J. Frantz, Shaker Heights, OH (US); Cherry Bochmann, Bay Village, OH (US)

Correspondence Address: Christopher B. Fagan, Fay, Sharpe, Fagan, Minnich & McKee, LLP, 7th Floor, 1100 Superior Avenue, Cleveland, OH, 44114-2518, US

(73) Assignee: Global Consumer Products, Inc.

(21) Appl. No.: 10/461,212

(22) Filed: Jun. 13, 2003

Related U.S. Application Data
(60) Provisional application No. 60/388,460, filed on Jun. 13, 2002.

(51) Int. Cl. B67D 1/00

(52) U.S. Cl. 222/78; 222/182

(57) ABSTRACT

The present invention relates to a dispenser for a food or beverage container that incorporates a three-dimensional design therein without significantly compromising the appearance of the three-dimensional design with the functionality of the device's dispensing apparatus. The dispenser includes a dispensing cap connected to an associated container and a three-dimensional design having (1) a first portion mounted on the dispensing cap and (2) a second portion pivotally connected to the first portion. The second portion is movable between a closed position wherein the second portion is pivoted until engagement with the first portion and an open position wherein the second portion is pivoted away from engagement with the first portion. The dispenser assembly further including a spout extending from the dispensing cap through the first portion of the three-dimensional design. The spout is accessible when the second portion is in the open position and the spout is hidden when the second portion is in the closed position.

This application claims the benefit of and hereby expressly incorporates herein by reference U.S. Provisional Patent Application Serial No. 60/388,460 entitled “FLIP-TOP DISPENSER”, which was filed on Jun. 13, 2002.

### BACKGROUND OF THE INVENTION

1. Field of the Invention

The present invention relates to a dispenser for a food or beverage container. More particularly, the present invention relates to a dispenser for a food or beverage container that incorporates a three-dimensional design therein without significantly compromising the appearance of the three-dimensional design with the functionality of the device's dispensing apparatus. The present invention finds particular application as a flip-top dispenser that incorporates a sculpted figure or character and will be described with particular reference thereto. However, it is to be appreciated that the invention may relate to other similar environments and applications.

2. Description of the Prior Art

Three-dimensional designs are often incorporated in consumer product designs to create purchase appeal. For example, a consumer product may include a sculpted figure, character, person, bust, emblem, logo or any other three-dimensional shape. The incorporated design may be a true likeness of someone or something or may be entirely fictional or fanciful. Further, the design may be generic or may be protected by, for example, patent, trademark, and/or copyright laws and the like. Often, well-known and protected characters, such as those from television and movies, are incorporated in consumer product designs to further increase purchase appeal.

One category of consumer products where it is particularly desirable to incorporate three-dimensional designs of well-known characters is in food and beverage containers. In particular, it is often desirable to incorporate such designs in the caps, also referred to herein as lids and covers, of food and beverage containers. However, the caps of many food and beverage containers already include one or more functional aspects that present unique problems to the incorporated three-dimensional design. More specifically, the functional aspects of the cap often interfere with the quality and integrity of the incorporated three-dimensional design and detract from the overall appearance thereof.

For example, beverage containers often include some type of screw-on cap that includes a dispensing apparatus. The dispensing apparatus is required to function for purposes of dispensing the beverage held in the container through the cap. When this type of beverage container and, more specifically, the cap of this type of beverage container includes a three-dimensional design, the dispensing apparatus either protrudes from the three-dimensional design or is included as part of the three-dimensional design.

When the three-dimensional design uses a well known character, it is often difficult to include the dispensing apparatus as part of the character because the character already has a predetermined shape and requires this shape in order to be recognizable. Allowing the dispensing apparatus to protrude from the three-dimensional design is also problematic. In particular, a dispensing apparatus protruding from a well known character is unsightly and detracts from the overall appearance of the three-dimensional character. This negatively affects the quality and integrity of the incorporated design.

Accordingly, there is a need for a dispenser and/or cap with a dispenser for a food or beverage container that permits a three-dimensional design to be incorporated therein without significantly compromising the appearance of the three-dimensional design while maintaining the dispenser's functionality. There is a further need for a dispenser and/or cap that permits a well-known three-dimensional design to be incorporated therein without negatively impacting the quality or integrity of the incorporated design with the functionality of the device's dispensing apparatus.

### SUMMARY OF THE INVENTION

The present invention provides a new and improved dispenser for a food or beverage container that overcomes the foregoing difficulties and others and provides the aforementioned and other advantageous features. More particularly, in accordance with one aspect of the present invention, the dispenser includes a dispensing cap connected to an associated container and a three-dimensional design having (1) a first portion mounted on the dispensing cap and (2) a second portion pivotally connected to the first portion.

The second portion is movable between a closed position wherein the second portion engages the first portion and an open position wherein the second portion is at a location pivoted away from engagement with the first portion. The dispenser assembly further includes a spout extending from the dispensing cap through the first portion of the three-dimensional design. The spout is accessible when the second portion is in the open position and the spout is hidden when the second portion is in the closed position.

According to another aspect of the present invention, a dispenser for a food or beverage container is provided. More particularly, in accordance with this aspect of the invention, the dispenser includes a dispensing cap connected to an associated container and a three-dimensional design piece. A connector pivotally connects the three-dimensional design piece to the dispensing cap and allows the design piece to be movable between a closed position wherein the design piece is positioned on the dispensing cap and an open position wherein the design piece is spaced apart from the dispensing cap. An opening is defined in the dispensing cap. The opening is hidden under the design piece when the design piece is in the closed position and the opening is accessible when the design piece is in the open position.

### BRIEF DESCRIPTION OF THE DRAWINGS

The invention may take physical form in various components and arrangements of components, and in various steps and arrangements of steps. The drawings are only for purposes of illustrating preferred embodiments of the invention and are not to be construed as limiting the invention.

FIG. 1 is a perspective view of a flip-top dispenser on a beverage container according to a first preferred embodiment of the present invention.

FIG. 2 is a partial perspective view of the flip-top dispenser on the beverage container of FIG. 1 shown in an open position.

FIG. 3 is an exploded perspective view of the flip-top dispenser of FIG. 1 showing a bottom three-dimensional design portion, a top three-dimensional design portion and a connector for pivotally connecting the top and bottom design portions.

FIG. 4 is a cross-sectional view of a dispensing spout of the flip-top dispenser of FIG. 1 shown in an open position.

FIG. 5 is a cross-sectional view of the dispensing spout of FIG. 4 shown in a closed position.

FIG. 6 is a perspective view of a first alternative connector which may be substituted for the connector of FIG. 3.

FIG. 7 is a perspective view of a second alternative connector which may also be substituted for the connector of FIG. 3.

FIG. 8A is an exploded perspective view of a flip-top dispenser having a bottom three-dimensional design portion, a top three-dimensional design portion and a connector for pivotally connecting the top and bottom design portions according to a second preferred embodiment of the present invention.

FIG. 8B is a top plan view of the connector of FIG. 8A.

FIG. 8C is a side elevational view of the connector of FIG. 8A.

FIG. 8D is a bottom plan view of the connector of FIG. 8A.

FIG. 9A is an exploded perspective view of a flip-top dispenser having a bottom three-dimensional design portion, a top three-dimensional design portion and a connector for pivotally connecting the top and bottom design portions according to a third preferred embodiment of the present invention.

FIG. 9B is a top plan view of the connector of FIG. 9A.

FIG. 9C is a side elevational view of the connector of FIG. 9A.

FIG. 9D is a bottom plan view of the connector of FIG. 9A.

FIG. 10 is an exploded perspective view of a flip-top dispenser according to a fourth preferred embodiment of the present invention.

FIG. 11 is a perspective view of a flip-top dispenser having a dispenser cap and a stationary three-dimensional design mounted thereon according to a fifth preferred embodiment of the present invention.

FIG. 12 is a partial exploded perspective view of a flip-top dispenser having a bobbling three-dimensional design mounted on the dispenser cap of FIG. 11.

FIG. 13 is a broken-away perspective view of the flip-top assembly according to a sixth preferred embodiment of the present invention

FIG. 14 is a partial enlarged cross-sectional view of the flip-top assembly of FIG. 13.

FIG. 15 shows a dispenser cap having a carrying clip disposed thereon.

### DETAILED DESCRIPTION OF THE INVENTION

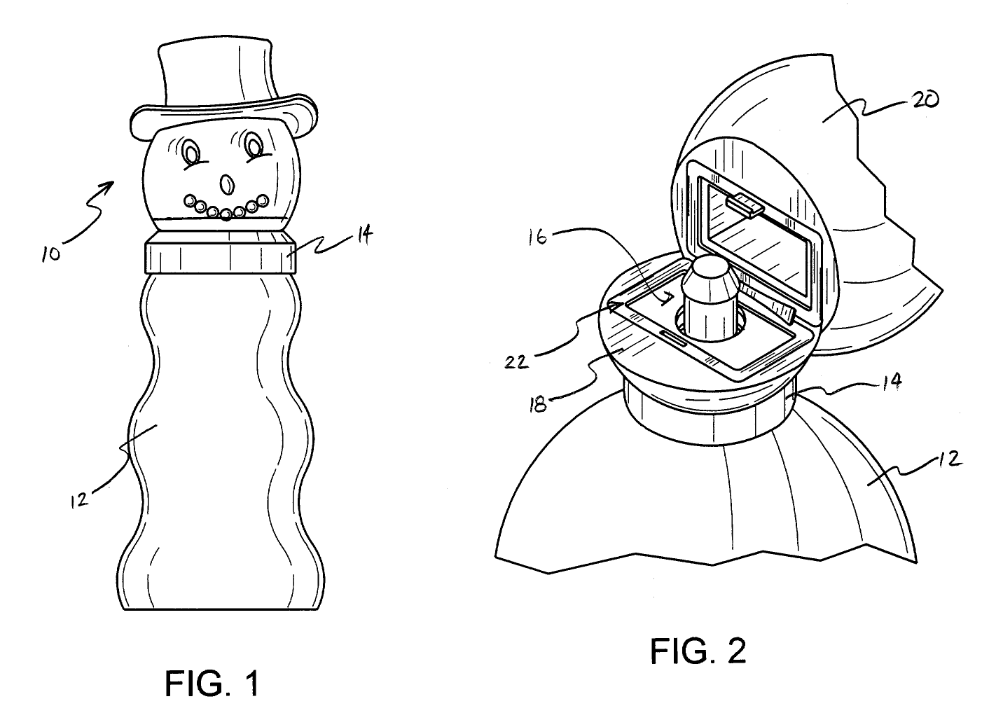

Referring now to the drawings wherein the showings are for purposes of illustrating preferred embodiments of the invention only and not for purposes of limiting the same, FIG. 1 shows a flip-top dispenser according to a first preferred embodiment of the present invention generally designated by reference numeral 10. In this embodiment, the dispenser 10 is configured for attachment to a container 12. More particularly, as will be described in more detail below, the dispenser 10 is threadedly attached to the container 12 for selective removal therefrom and reattachment thereto.

As shown, the dispenser 10 incorporates a three-dimensional design. The purpose of the incorporated design may be, for example, to increase the purchase appeal of the container 12 or a food or beverage item contained in the container. In the illustrated embodiment, the design is a three-dimensional sculpted character and, more particularly, a snowman head. Alternatively, the design could be any other sculpted character, figure, person, bust, emblem, logo or other three-dimensional shape. The design can be a true likeness of someone or something or may be entirely fictional or fanciful. Moreover, the design can be a protected design used by the owner of the protected design or with permission of the owner or the design may be entirely generic.

In contrast to the prior art, the dispenser 10 incorporates a design and maintains its usefulness as a dispenser without compromising the quality or integrity of the incorporated design. For example, the dispenser 10 includes minimal disturbances to the incorporated design while still providing the functional requirements necessary for a dispensing device. As discussed above, the prior art dispensers that incorporate three-dimensional designs often compromise the quality and/or integrity of the design through their employment of functional aspects of a dispenser appearing in the incorporated design. For example, some prior art dispensers incorporate a character and have a dispensing spout protruding from the character's head or back.

With additional reference to FIG. 2, the dispenser 10 includes a dispensing cap 14 threadedly connected to the container 12. The dispensing cap 14 includes a movable spout 16 that allows a fluid or other substance held in the container 12 to be dispensed through the cap 14 when the spout is in an open position as will be described in more detail below. The dispenser 10 further includes a three-dimensional design or snowman head having a lower portion or piece 18 and an upper portion or piece 20. The upper piece 20 is hingedly or pivotally connected to the lower portion 18 by a frame connector 22.

With specific reference to FIG. 1, the dispenser 10 is shown in a closed position wherein the snowman head design is intact and hides the dispensing spout 16 (FIG. 2). Thus, the snowman head design is unaffected by the dispensing function of the cap and spout and the overall quality of the snowman head design is not detrimentally impacted. With specific reference to FIG. 2, when the dispenser 10 is in an open position, the upper portion 20 folds open to reveal the dispensing spout 16. With the upper portion 20 folded out of the way, the spout 16 can be moved to its open position to allow the liquid or other substance in the container 12 to be dispensed through the cap 14.

Alternatively, the dispensing spout 16 can be replaced with any another means for dispensing from a container. For example, the dispensing spout could be replaced with a straw or sipper, a chute, an opening, etc. In these and any further alternative configurations, the means for dispensing could be used to dispense a liquid, semi-solid or a solid or plurality of solids from the container 12.

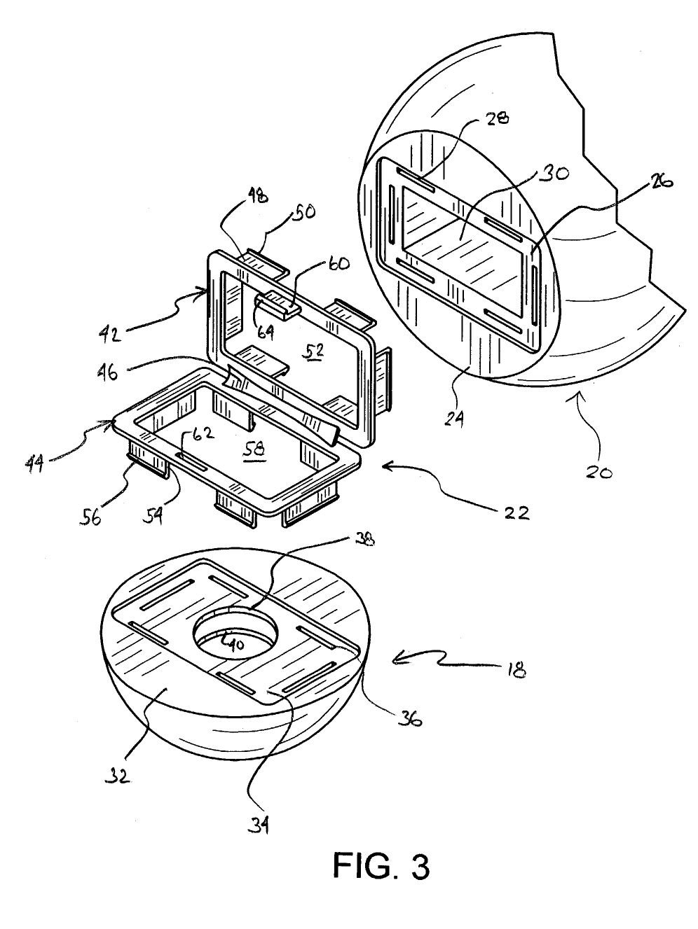

With reference to FIG. 3, the upper portion 20 is generally a hollow structure that is manufactured through a rotational molding process utilizing any type of thermoplastic rubber or thermoplastic elastomer. More specifically, in the preferred embodiment, vinyl is the material used for rotational molding the upper portion 20. After molding, the upper portion 20 is decorated with a paint, dye, stain or other decorative substance. Of course, alternative manufacturing processes and materials could be used to make the upper portion and all known processes and materials are to be considered within the scope of the present invention. For example, an injection molding process could be used to produce the upper portion 20 and/or a synthetic material, other than vinyl, could be used to form the upper portion 20, particularly those materials that can be easily decorated after molding with a paint, dye, stain or other decorative substance.

The upper portion 20 includes a mating surface, bottom surface 24, defining a recessed area 26 and a plurality of slots 28 in the recessed surface. An opening 30 defined in the bottom surface 24 connects to an interior cavity of the upper portion 20. The opening 30 and the hollow interior of the upper portion 20 receive the dispensing spout 16 when the dispenser 10 is in the closed position to hide the dispensing spout 16 and maintain the integrity of the three-dimensional design 18, 20 (FIG. 1).

The bottom portion 18 is also a generally hollow structure and is manufactured in the same manner and formed of the same material as the top portion 20. Like the upper portion 20, the bottom portion 18 includes a mating surface, top surface 32, that defines a recessed area 34 and a plurality of slots 36 in the recessed area 34. An opening 38 is defined in the top surface 32 that connects to an interior cavity of the lower portion 18. Another opening 40 is defined on an underside of the bottom portion. The underside opening 40 is aligned with the opening 38 and connects to the interior cavity of the lower portion 18. The bottom portion openings 38, 40 allow the dispensing spout 16 to pass through the bottom portion 18 as will be described in more detail below.

With continued reference to FIG. 3, the frame connector 22 includes an upper rectangular section 42 and a lower rectangular section 44. The lower section 44 is pivotally connected to the upper section 42 by a pivot or hinge 46. In the preferred embodiment, the hinge 46 is a bow-tie-type hinge. However, alternative hinge types are contemplated and all known hinge types are to be considered within the scope of the present invention. For example, the hinge 46 could be a strap-type hinge, a loop and pin hinge, a living hinge or any other hinge or structure that enables the frame sections 42, 44 to pivot relative to one another.

The upper section 42 includes a plurality of tabs 48 that are received in the slots 28 of the bottom surface 24 of the upper portion 20 for securing the upper section 42 to the bottom surface 24. Optionally, the tabs 48 include barbs 50 for further securing the upper section 42 to the upper portion 20. Also optionally, an adhesive can be added between the upper section 42 and the bottom surface 24 to even further secure the upper section 42 to the upper portion 20. When the upper section 42 is connected to the bottom surface 24, the upper section 42 rests in the recessed area 26 of the bottom surface 24 so that the upper section is flush or level with an area of the bottom surface that is not recessed. The upper section 42 includes an opening 52 aligned with the opening 30.

Similar to the upper section 42, the lower section 44 includes a plurality of tabs 54 that are received in the slots 36 of the top surface 32 of the lower portion 18 for securing the lower section 44 to the top surface 32. Also like the upper section 42, the tabs 54 can optionally include barbs 56 and/or an adhesive can be optionally used between the top surface 32 and the lower section 44 for purposes of further securing the lower section 44 to the lower portion 18. When the lower section 44 is connected to the top surface 32, the lower section 44 rests in the recessed area 34 of the top surface 32 so that the lower section 44 is flush or level with an area of the top surface that is not recessed. The lower section 44 includes an opening 58 aligned with the opening 38.

Although the upper portion 20 is shown having six (6) slots 28 for receiving six (6) corresponding tabs 48 and the lower portion 18 is shown having six (6) slots 36 for receiving six (6) corresponding tabs 54, any number of slots and tabs can be used for connecting the upper section 42 to the upper portion 20 and for connecting the lower section 44 to the lower portion 18. Additionally, other means for connecting the upper and lower sections 42, 44 to the respective upper and lower portion 18, 20 can be used in place of or in addition to the respective tab and slot arrangements 28, 48 and 36, 54 including, for example, a tongue and groove arrangement, a latch and catch arrangement, snaps, etc.

When the dispenser 10 is in the closed position, the connector 22 is entirely hidden. This occurs as a result of the upper and lower sections 42, 44 residing in the recessed areas 26, 34 of the top and bottom surfaces 24, 32. With the connector 22 not visible when the dispenser is closed, the integrity of the three-dimensional design incorporated in the dispenser 10 is maintained and unaffected by the connector 22.

With reference still to FIG. 3, the connector 22 includes a locking device or locking means for maintaining the dispenser 10 in a closed position. The lock device includes a tab 60 depending from the upper section 42 and a slot 62 for receiving the tab 60 defined in the lower section 44. The tab 60 includes a barb 64 so that when the tab 60 is received in the slot 62 the upper section 42 is prevented from pivoting from the lower section 44. Thus, the dispenser can be maintained in its closed position and generally prevented from flipping open unintentionally when the dispenser is shipped, handled or stored. Of course, the tab could be on lower section 44 and the corresponding slot could be on the upper section 42.

To open the dispenser 10 and pivotally move the upper section 42 from the lower section 44, a pull-out force is applied to the upper section via the upper portion 20 sufficient enough to overcome the locking engagement between the tab 60 and the slot 62, i.e., the tab 60 and barb 64 and/or the slot 62 are elastically deformed a sufficient amount to allow the tab 60 to be removed from the slot 62. Of course, other locking devices or locking means can be employed. For example, an interference fit arrangement could be employed between a tab and a receiving opening, a latch arrangement could be employed, etc.

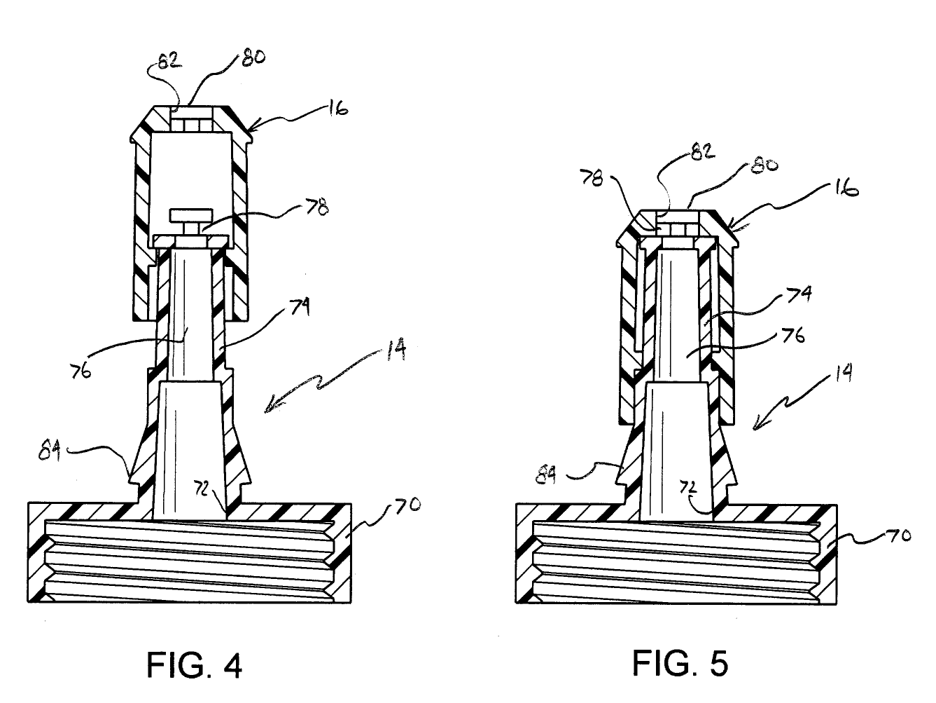

With reference to FIGS. 4 and 5, the dispensing cap 14 is generally a conventional-type cap that threadedly connects to the container 12. The cap 14 includes a base portion 70 having threads for connecting to the container 12 and an opening 72 defined in the base portion 70. The cap 14 further includes a tubular portion 74 having a passageway 76 fluidly connected to the opening 72. At a distal end of the tubular portion 74, an opening 78 is defined that connects to the passageway 76. The dispensing spout 16 is telescopingly received over the tubular portion 74 and slidably movable relative to the base portion 70. The spout 16 is movable a distance of preferably about one-quarter (¼) inch to about two (2) inches, preferably about one-half (½) inch to one and half (1½) inches, and more preferably , one-half (½) inch to one (1) inch, depending on the shape and position of the lower and upper portions 18, 20 that need to be cleared when the dispenser 10 is open.

The spout 16 includes an opening 80 at one end thereof which, together with the opening 78, forms a valve that controls the passage of fluid or any other substance from the container 12 and through the opening 80. Thus, when the spout 16 is in a first, closed position (FIG. 5), the valve is closed and the contents of the container 12 are prevented from passing through the cap 14, i.e., an interior wall 82 defining the opening 80 seals closed the annular opening 78. When the spout 16 is in a second, open position (FIG. 4), the valve is open and the contents of the container 12 are allowed to pass through the cap 14, i.e., the opening 80 is unobstructed and the container's contents are free to pass from the container 12 and through the openings 72, 78, 80.

The tubular portion 74 includes one or more barbs 84 positioned adjacent the base portion 70 for securing the lower portion 18 on the cap 14. More particularly, an outer diameter of the barbs 84 is larger than a diameter of the opening 40 at the bottom of the lower portion 18 which generally prevents pull-off of the lower portion 18 from the cap 14. To connect the bottom portion 18 to the cap 14, a force is applied sufficient enough to elastically deform the lower opening of the lower portion 18 such that it stretches over the barbs 84.

To assemble the three-dimensional design 18, 20, the connector 22 is attached to the lower and upper portions 18, 20. The openings 30, 38, 40, 52, 56 allow the tubular portion 74 and the spout 16 to pass therethrough and be concealed by the portions 18, 20 of the three-dimensional design. Thus, when the dispenser 10 is in the closed position, the dispensing components 14, 16 are concealed and do not adversely affect the quality or integrity of the three-dimensional design. When the dispenser is moved to its open position, i.e., the top portion 20 is pivoted back along the hinge 46, the spout 16 is accessible and movable to its open position to allow the contents of the container 12 to be dispensed therefrom.

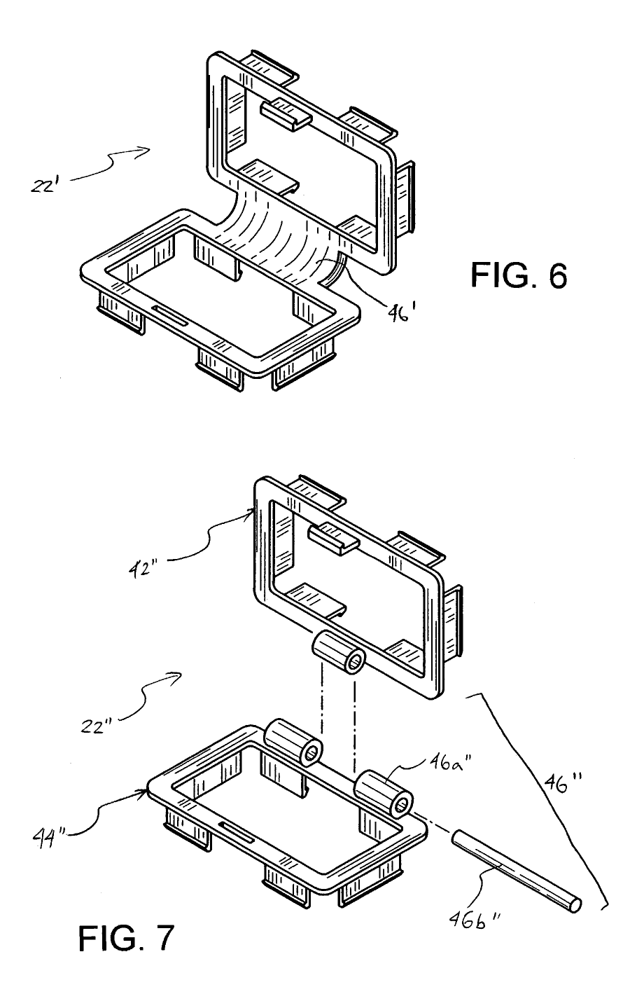

With reference to FIG. 6, a frame connector 22′ is illustrated that can be substituted for the frame connector 22. In most respects, the frame connector 22′ is like the frame connector 22. However, the frame connector 22′ includes a strap-type hinge 46′. With reference to FIG. 7, another frame connector 22″ is illustrated that can be substituted for the frame connector 22. Again, in most respects, the frame connector 22″ is like the frame connector 22. However, the frame connector 22″ includes a hinge assembly 46″ having hinge pin receiving structures 46a″ and a hinge pin 46b″ extending through the receiving structures 46a″ for pivotally connecting the upper section 42″ to the lower section 44″. In another alternative embodiment, it is also possible to replace the connector 22 with an integrally formed hinge between the upper and lower portions 18, 20. The integrally formed hinge could be achieved by molding one continuous piece as the three-dimensional design which would include a hinge built into the mold.

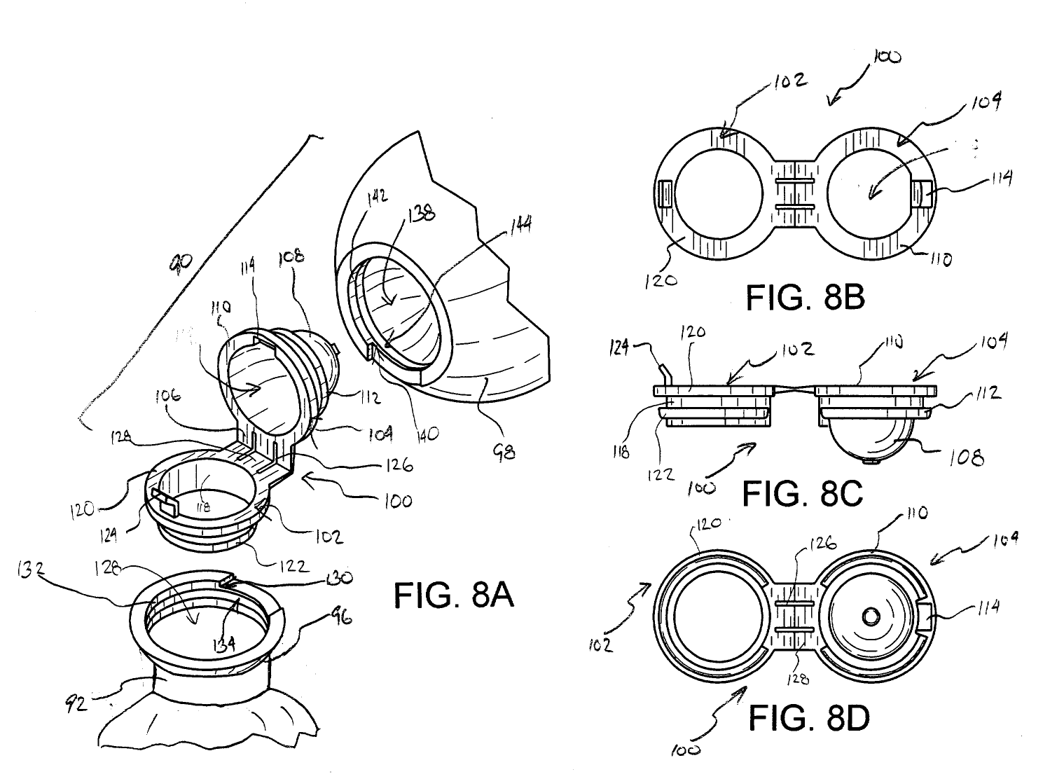

With reference to FIG. 8A, a dispenser 90 is shown according to a second preferred embodiment of the present invention. In many respects, the dispenser 90 is like the dispenser 10 of the first preferred embodiment. The dispenser 90 includes a cap 92 having a dispensing spout (not shown), a lower portion 96 of a three-dimensional design, an upper portion 98 of the three-dimensional design and a connector 100 for pivotally connecting the upper portion 98 to the lower portion 96.

With additional reference to FIGS. 8B-8D, unlike the connector 22, the connector 100 includes a lower circular section 102 and an upper circular section 104 pivotally connected to the lower circular section 102 by a hinge 106. The circular section 104 includes a dome 108 extending upwardly from an upper annular frame 110. An interior wall of the dome 108 is formed contiguously with an interior wall of the annular frame 110. An annular flange 112 is spaced apart from the annular frame 110 and extends radially outwardly from an exterior wall of the dome 108. The annular frame 110, the dome 108 and the flange 112 together form an annular groove structure. An opening 114 is provided through the annular frame 110 opposite the hinge 106 and an optional recess is provided in the annular flange 112 aligned with the opening 114.

A tubular flange 118 extends downwardly from a lower annular frame 120 of the lower circular section 102. An interior wall of the tubular flange 118 is formed contiguously with an interior wall of the annular frame 120. An annular flange 122 is spaced apart from the frame 120 and extends radially outwardly from an exterior wall of the tubular flange 118. The annular frame 120, the tubular flange 118 and the annular flange 122 together form an annular groove structure. A tab 124 extends upwardly from the annular frame 120 opposite the hinge 106 and is receivable in the opening 114 when the upper and lower sections 102, 104 are pivoted toward one another.

The hinge 106 includes two slits 126 oriented generally normal to a pivot axis of the hinge 106. The slits 126 divide the hinge 106 into three sections 128 which provides increased strength and flexibility to the hinge 106. Further, failure of one of the hinge sections 128 does not render failure of any of the other sections 128 more likely. In a typical, single section hinge, a tear in the hinge can severely weaken the hinge and will likely result in failure of the entire hinge. Thus, the slit and sectional hinge arrangement provides a more resilient hinge. Of course, any number of slits and sections could be used and other slit configurations could be employed. All such slit and sectional hinge arrangements are to be considered within the scope of the present invention.

The lower portion 96 includes an opening 128 and a recessed area 130 for flushly receiving the connector lower section 102. Further, the lower portion 96 includes an annular flange 132 that is received in the groove structure of the lower section 102. Below the flange 132, the lower portion 96 includes a groove structure 134 having a groove for receiving the annular flange 122. The cooperation or engagement between lower circular section groove structure and the flange 132 and the cooperation or engagement between the lower portion groove structure 134 and the flange 122 secures the connector 100 to the lower portion 96.

Similarly, the upper portion 98 includes an opening 138 and a recessed area 140 for flushly receiving the connector upper section 104. Further, the upper portion 98 includes an annular flange 142 that is received in the groove structure of the upper section 104. Above the flange 142, the upper portion 98 includes a groove structure 144 having a groove for receiving the annular flange 112 of the upper section 104. The cooperation or engagement between the upper circular section groove structure and the annular flange 142 and the cooperation or engagement between the upper portion groove structure 144 and the flange 112 secures the connector 100 to the upper portion 98.

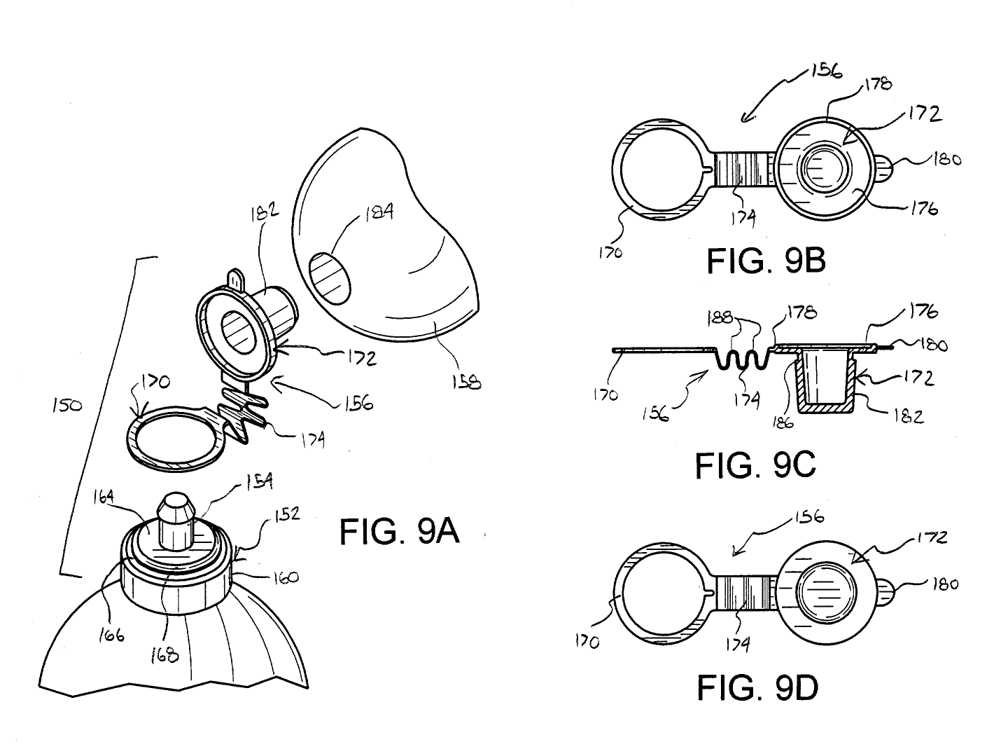

With reference to FIG. 9A, a dispenser 150 is shown according to a third preferred embodiment of the present invention. The dispenser 150 includes a dispensing cap 152 having a dispensing spout 154. In most respects, the dispensing cap 152 is like the dispensing cap 14 of the first preferred embodiment. A connector 156 pivotally attaches a three dimensional design piece 158 to the dispensing cap 152. More particularly, the design piece 158 is pivotally movable between a closed position wherein the piece 158 fits over the dispensing spout 154 to hide the dispensing spout 154 and an open position wherein the piece 158 is removed from the dispensing spout 154 allowing access to the dispensing spout for use thereof.

The dispensing cap 152 includes a base portion 160 and a tubular portion (not shown) extending from the base portion 160. The tubular portion is like the tubular portion 74 of the first preferred embodiment but does not include barbs. Rather, the tubular portion includes a shoulder 164 adjacent a top 166 of the base portion 160 and a flange 168 extending radially outwardly adjacent a top of the shoulder 164. Thus, the flange 168 is spaced slightly apart from the top 166 of the base portion 160. The height of the tubular portion is such that the dispensing spout 154 rests against or close to the shoulder 164 when the spout 154 is in its closed position.

With additional reference to FIGS. 9B-9D, the connector 156 includes a lower section 170 and an upper section 172 connected to the lower section 170 by a hinge 174. The lower section 170 is an annular ring having an inner diameter slightly larger than an outer diameter of the shoulder 164 and smaller than a diameter of the flange 168. Thus, when assembled, the lower section 170 is free to rotate about the shoulder 164 but generally cannot be removed from its position between the top 166 of the base portion 160 and the flange 168.

The upper section 172 includes a generally flat circular wall 176 having a skirt 178 depending from an outer edge of the wall 176. An inner diameter of the skirt 178 is substantially similar or slightly larger than the diameter of the flange 168 such that when the upper section is pivoted to a closed position the skirt 178 frictionally grips the flange 168 to lock the connector 156 in the closed position. To unlock the skirt 178 from the flange 168, a sufficient force must be applied to the upper section 172 to pull it apart from the lower section 170. A tab 180 is disposed on the skirt 178 at a location opposite the hinge 174 for providing a surface to apply said force when it is desired to unlock the connector 156.

A cup member 182 extends from the wall 176 in a direction opposite of the skirt 178. The cup 182 has an inner diameter large enough to receive the spout 154 when the connector 156 is in its closed position. An outer diameter of the cup 182 is appropriately sized to be received in an opening 184 on an underside of the three-dimensional design piece 158. An exterior wall of the cup 182 includes barbs 186 for securing the piece 158 to the connector 156.

The hinge 174 includes one or more waves 188 for allowing the design piece 158 to be positioned in a non-interfering location when the connector 156 is in its open position. More particularly, the waves 188 in the hinge 174 allow the design piece 158 to pivot to a location spaced apart from dispensing cap 152 which allows generally unhindered access to the dispensing spout 154. The rotational connection between the lower section 170 and the cap 152 allows the three-dimensional design piece 158 to be rotated relative to the container such as might be necessary to align a front of the piece 158 with a desired portion of a label (not shown) on the container.

With reference to FIG. 12, a connector 156′ and cap 152′ are shown according to a fourth preferred embodiment of the present invention. In most respects, the connector and cap 152′, 156′ are like the connector and cap 152, 156 of the third preferred embodiment. However, the connector 156′ includes hinge 174′ that is a living hinge. Thus, a 3-D design piece carries on cup 182′ is urged toward either its open position or its closed position and requires a sufficient force to overcome this urging. Generally, whichever position the design piece is closer to is the position that it will be urged toward by the living hinge 174′.

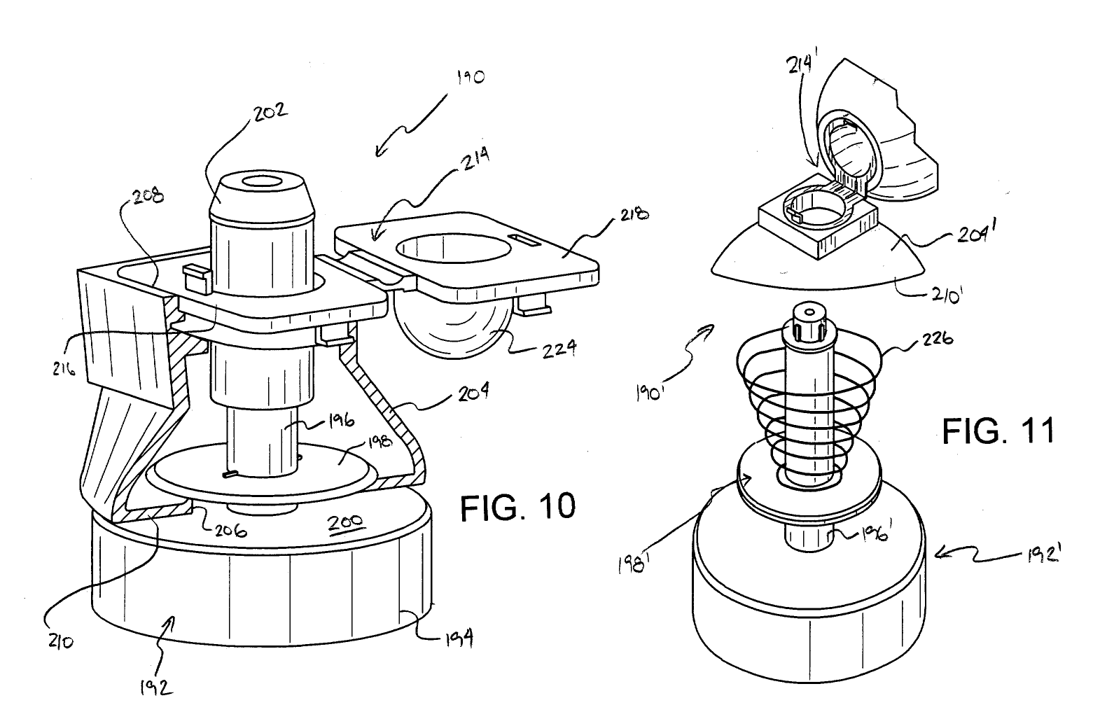

With reference to FIG. 10, a portion of a dispenser 190 is shown according to a fifth preferred embodiment of the present invention. In many respects, the dispenser 190 is like the dispenser 10 of the first preferred embodiment. However, the dispenser 190 includes a dispenser cap 192 that can be used to mount a generally stationary three-dimensional design or, alternatively, to mount a moving or bobbling three-dimensional design as will be described in more detail below. In FIG. 10, the cap 192 is used in a configuration for mounting a stationary three-dimensional design.

The cap 192 includes a base portion 194 having a tubular portion 196 extending therefrom. A flange 198 extends radially outwardly from the tubular portion 196 at a location spaced apart slightly from a top surface 200 of the cap 192. As in the previously discussed embodiments, the tubular portion 196 supports a dispensing spout 202. A bottom portion 204 of the three-dimensional design connects to the cap 192. More particularly, the bottom portion 204 is generally hollow and defines a pair of openings, bottom opening 206 and top opening 208. The bottom opening 206 pulls over the flange 198 which is slightly larger than the bottom opening to prevent pull-off of the bottom portion 204 from the cap 192. The bottom portion 204 is elastically deformed for purposes of getting the flange 198 in the opening 206. Additionally, the bottom portion 204 can be mounted to the cap 192 very soon after molding of the bottom portion such as when it is still warm from the molding process to further assist in getting the flange 198 in the opening 206. A bottom wall 210 of the bottom portion 204 then rests on the top surface 200 of the cap 192.

Similar to the connector 22 of the first preferred embodiment, the dispenser 190 includes a connector 214. A bottom section 216 of the connector 214 is secured to the bottom portion 204 and a top section 218 of the connector 214 is secured to the top portion of the three-dimensional design. The top and bottom sections 216, 218 of the connector 214 are optionally rectangular with rounded corners to make assembly to the top and bottom portions of the three-dimensional design relatively easier. The connector 214 further includes a dome 224 that functions like the dome 108 of the second preferred embodiment. In most other respects, the dispenser 190 functions like the dispenser 10 of the first preferred embodiment.

Although the shape of the top and bottom sections 216, 218 of the connector 214 varies from the previously discussed preferred embodiments, the function is essentially the same. As should be evident, the shape of the top and bottom sections of the connectors of any of the embodiments herein discussed can vary and may include, for example, an oval shape, a triangular shape, etc. In some instances, it may be desirable to shape the connector sections such that they outline a shape of the three dimensional design. For example, if the three-dimensional design is generally rectangular, then the connector sections could be rectangular.

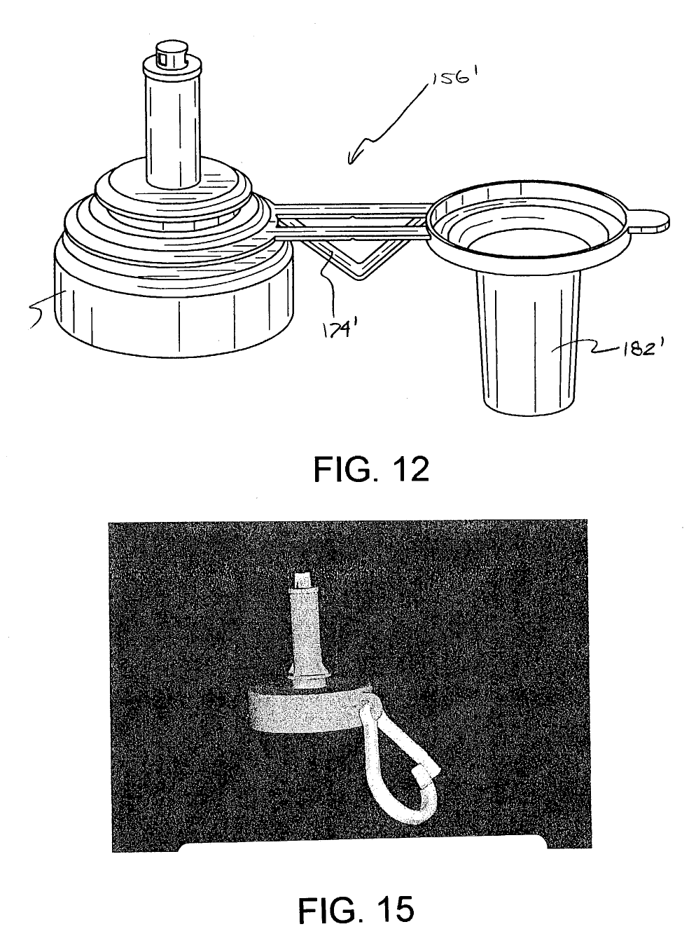

With reference to FIG. 11, a modified dispenser 190′ is shown wherein cap 192′ is used to mount a moving or bobbling three-dimensional design 204′. In the dispenser 190′, a spring 226 is included above flange 198′ and below connector 214′. Further, base portion 204′ of the three-dimensional design has a shortened height. More particularly, bottom wall 210′ of the base portion 204′ rests against the flange 198′. This allows the three-dimensional design to move angularly relative to tubular portion 196′ of the dispensing cap 192′. The spring 226 functions to return the three-dimensional design to a normal, upright position after the design has been moved angularly relative to the tubular portion 196′.

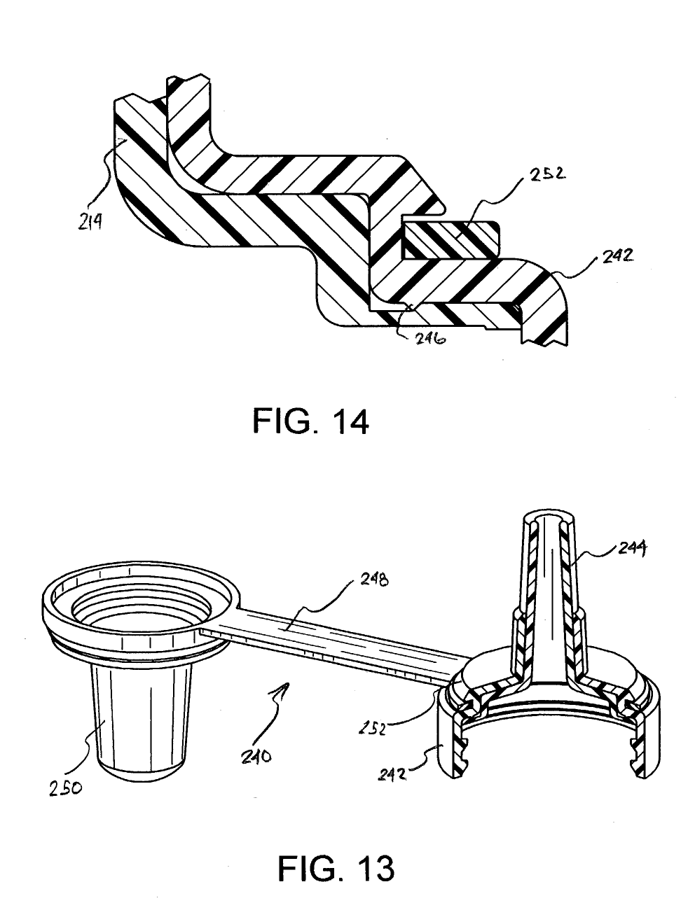

With reference to FIG. 13, a dispenser assembly 240 is shown according to a sixth preferred embodiment of the present invention. In most respects, the dispenser assembly 240 functions like the dispenser 150. However, the dispenser assembly 240 is configured for use with a straw as opposed to a dispensing spout. More particularly, the dispenser assembly 240 includes a dispensing cap 242 that fits over a straw structure 244. With additional reference to FIG. 14, the cap 242 can include a ridge 246 for holding the straw structure 244 in position relative to the cap 242. The assembly 240 includes a strap-type hinge connector 248 that functions much like the connector 156. The connector 248 includes a cup structure 250 that attaches to an end of the stem structure 214 and an annular section 252 that connects to the cap 242.

With reference to FIG. 15, a dispensing cap 260 is shown having a carrying device connected thereto. More specifically, a bottom portion 262 of the cap 260 includes a U-shaped member 264 extending from a side of the bottom portion. A conventional clip device 266 is connected to the U-shaped member 264 and can be used to connect the dispensing cap 260 and any dispenser assembly the cap 260 is a component in to another item such as a backpack, jacket, etc. The carrying device of the dispensing cap 260 could be added as a feature to any of the dispensing caps discussed herein or, alternatively, to another component of the dispenser assembly.

The invention has been described with reference other preferred embodiments. Obviously, modifications and alterations will occur to others upon reading and understanding the preceding detailed description. It is intended that the invention be construed as including all such modifications and alterations insofar as they are within the scope of the appended claims and the equivalents thereof.

Having thus described the preferred embodiments, the invention is now claimed to be:

1. A dispenser for a food or beverage container, the dispenser comprising:
a dispensing cap connected to an associated container;
a three-dimensional design having (1) a first portion mounted on said dispensing cap and (2) a second portion pivotally connected to said first portion, said second portion movable between a closed position wherein said second portion engages said first portion and an open position wherein said second portion is at a location pivoted away from engagement with said first portion; and
a spout extending from said dispensing cap through said first portion of said three-dimensional design, said spout accessible when said second portion is in said open position and said spout hidden when said second portion is in said closed position.

2. The dispenser of claim 1 further including:
a connector having a hinge for pivotally connecting said second portion to said first portion, said connector including an upper section on one side of said hinge connected to said second portion and a lower section on an opposite side of said hinge connected to said first portion.

3. The dispenser of claim 2 wherein one of said upper section and said lower section includes at least one tab and the other one of said upper section and said lower section includes at least one corresponding slot for receiving said at least one tab.

4. The dispenser of claim 3 wherein said at least one tab includes a barb for locking said at least one tab in said at least one corresponding slot.

5. The dispenser of claim 2 wherein said lower section is generally rectangular or circular and defines an opening through which said spout passes.

6. The dispenser of claim 2 wherein said first and second portions include recessed areas for receiving respective upper and lower frame sections for allowing outer surfaces of said upper and lower frame sections to be contiguous with mating surfaces of said first and second portions.

7. The dispenser of claim 2 wherein one of said first portion and said lower section includes at least one tab and the other one of said first portion and said lower section includes at least one corresponding slot for receiving said at least one tab.

8. The dispenser of claim 7 wherein said at least one tab includes a barb for securing said at least one tab in said at least one corresponding slot.

9. The dispenser of claim 2 wherein one of said first portion and said lower section includes a groove structure and the other one of said first portion and said lower section includes a tongue adapted to be received in said groove structure.

10. The dispenser of claim 2 wherein said hinge of said frame connector is one of a bow-tie hinge, a strap hinge, a pivot pin hinge and a living hinge.

11. The dispenser of claim 2 wherein said hinge includes at one slit dividing the hinge into hinge sections.

12. The dispenser of claim 2 wherein the upper section includes a dome that provides a guiding surface for said spout when the second portion is moved from said open position to said closed position.

13. The dispenser of claim 12 wherein said upper section includes:
a generally circular frame having an interior surface;
said dome extending from said circular frame and having an interior dome surface contiguous with said circular frame interior surface; and
an annular flange protruding radially outwardly from an exterior surface of said dome and spaced apart from said circular frame, said circular frame, said dome and said flange together forming a groove structure for receiving an annular flange of said second portion.

14. The dispenser of claim 1 wherein said spout is movable between a closed position wherein a fluid held in said associated container is generally obstructed from passing through said cap and an open position wherein said fluid is generally able to pass through said cap.

15. The dispenser of claim 1 wherein said spout includes (1) a tubular structure having a passageway extending from an opening in said cap and (2) a movable dispensing spout telescopingly received around an end of said tubular structure, said dispensing spout including an opening fluidly connectable to said passageway when said movable dispensing spout is in an open position and fluidly obstructed from said passageway when said movable dispensing spout is in a closed position.

16. The dispenser of claim 11 wherein said tubular structure includes at least one barb for holding said first portion of said three-dimensional design on said cap.

17. The dispenser of claim 11 wherein said tubular structure includes a flange and a spring is supported by said flange, said lower portion is mounted over said spring and spaced apart from a base portion of said dispensing cap such that said three-dimensional design is able to move angularly relative to a distal end of said tubular structure.

18. The dispenser of claim 1 further including:
a clip-on device connected to said dispensing cap.

19. A dispenser for a food or beverage container, the dispenser comprising:
a dispensing cap connected to an associated container;
a three-dimensional design piece;
a connector pivotally connecting said three-dimensional design piece to said dispensing cap and allowing said design piece to be movable between a closed position wherein the design piece is positioned on the dispensing cap and an open position wherein the design piece is spaced apart from said dispensing cap; and
an opening defined in said dispensing cap, said opening hidden under said design piece when said design piece is in said closed position and said opening accessible when said design piece is in said open position.

20. The dispenser of claim 17 wherein said opening in said dispensing cap is defined by a tubular structure extending from said dispensing cap and hidden under said design piece when said design piece is in said closed position and revealed when said design piece is in said open position.

21. The dispenser of claim 17 wherein said connector includes a hinge having waves that spaces said design piece away from said dispensing cap when said design piece is in said open position.

22. The dispenser of claim 17 wherein said connector includes a living hinge.
